(19) United States
(12) Patent Application Publication
(10) Pub. No.: US 2022/0138582 A1
(43) Pub. Date: May 5, 2022

(54) INTELLIGENT LAYOUT DESIGN METHOD OF CURVILINEARLY STIFFENED STRUCTURES BASED ON IMAGE FEATURE LEARNING

(71) Applicant: DALIAN UNIVERSITY OF TECHNOLOGY, Dalian, Liaoning (CN)

(72) Inventors: Peng HAO, Dalian, Liaoning (CN); Kunpeng ZHANG, Dalian, Liaoning (CN); Dachuan LIU, Dalian, Liaoning (CN); Bo WANG, Dalian, Liaoning (CN); Gang LI, Dalian, Liaoning (CN); Yuhui DUAN, Dalian, Liaoning (CN); Yunfeng SHI, Dalian, Liaoning (CN); Yutong WANG, Dalian, Liaoning (CN)

(21) Appl. No.: 17/424,785

(22) PCT Filed: Feb. 22, 2021
(86) PCT No.: PCT/CN2021/077160

§ 371 Date: Jul. 21, 2021

(30) Foreign Application Priority Data
Jul. 8, 2020 (CN) 202010649313.5

(51) Int. Cl. G06N 3/08; G06V 10/774; G06F 30/17; G06F 30/27

(52) U.S. Cl. CPC G06N 3/086; G06F 30/27; G06F 30/17; G06V 10/7753

(57) ABSTRACT

An intelligent layout design method of curvilinearly stiffened structure based on image feature learning. Firstly, the design variables of the curvilinearly stiffened structure are determined based on the path function. The autoencoder network is built to complete the learning of the structural characteristics of the image, and the transfer learning of the model is further carried out. The convolution neural network is built to complete the learning of the image set with mechanical response labels. Finally, the evolutionary algorithm is used to optimize the layout of the curvilinearly stiffened structure based on the model. The invention solves the problem that the traditional optimization method is difficult to deal with the optimization design with many and variable design variables, and is expected to become one of the most potential technical means involved in the layout design of components in the engineering field.

### TECHNICAL FIELD

The invention belongs to the field of engineering thin-walled stiffened structure design, especially relates to an intelligent design method of curvilinearly stiffened structure layout based on image feature learning.

### BACKGROUND

Due to the larger structural design space, the curvilinearly stiffened layout design will make the stiffness distribution and loading path of the stiffened structures more flexible and improve the bearing efficiency of the structures. Therefore, it has become a research hotspot in the field of launch vehicles, aircraft, ships and other engineering. However, compared with the traditional linear stiffened structures, the path representation function of the curvilinearly stiffened structures is more complex, which leads to the explosive growth of design variables, and thus seriously restricts the layout optimization design of the curvilinearly stiffened structures. Especially for the curvilinearly stiffened structures with dynamic changes in the number of design variables, the structural optimization design method based on the traditional surrogate model is more difficult to carry out.

### SUMMARY

In view of many difficulties in the layout optimization design of curvilinearly stiffened structures, the present invention proposes an intelligent design method for the layout of curvilinearly stiffened structures based on image feature learning. The structural characteristics of the layout image of the curve path are extracted by building a deep learning network, and the layout design of the curvilinearly stiffened structures is further optimized. The difficulties faced by the traditional optimization methods are solved, and an effective and feasible method is provided for the related fields.

In order to achieve the above purpose, the technical solution adopted by the invention is as follows.

An intelligent design method of curvilinearly stiffened structural layout based on image feature learning, including the following steps:

Step 100: select the curvilinearly stiffened path function to generate the image datasets, which is input into the autoencoder network for unsupervised learning training, and complete the extraction of the structural characteristics of the curvilinearly stiffened images, including the following sub-steps:

Step 101: select the path function B(t), and determine the path function design variables of stiffened thin-walled structures, as shown in formula (1.1);

B(t)=(1−t)²Pₛ(xₛ,yₛ)+2t(1−t)Pₘ(xₘ,yₘ)+t²Pₑ(xₑ,yₑ),t∈[0,1] (1.1)

where B(t) is the path function, t is the path function control variable, Pₛ(xₛ, yₛ) is the starting point coordinates in the path, Pₘ(xₘ, yₘ) is a point coordinates in the path, Pₑ (xₑ, yₑ) is the end point coordinates in the path;

Step 102: limit the path function of the curvilinearly stiffened structure. Specifically, the path function type is determined according to the combination of different boundary types of the structure, and the design domain space of the path function of the curvilinearly stiffened structure is constrained;

Step 103: generate the image datasets of curvilinearly stiffened structural layout. Specifically, determine the size of each curvilinearly stiffened structure image (m*n), and generate the training image datasets N₀ used for unsupervised learning;

Step 104: build decoding network model E and encoding network model D for the layout image of curvilinearly stiffened structure;

Step 105: combine image decoding network model E and encoding network model D to form autoencoder network model;

Step 106: input curvilinearly stiffened layout image datasets N₀ into autoencoder network model;

Step 107: complete the training process of autoencoder network model for curvilinearly stiffened layout image datasets No;

Step 108: extract the decoding network model E after the autoencoder network model trained;

Step 200: establish the analysis model of mechanical response of curved stiffened structure, form training datasets for supervised learning, and further input the convolutional neural network model built by step 108 decoding network model and full connection layer to complete the learning of mechanical response of curved stiffened structure, including the following sub-steps:

Step 201: establish curvilinearly stiffened structure according to curve path function B(t);

Step 202: set the boundary conditions and analyze the structural mechanical response;

Step 203: the training datasets and testing datasets for training and testing of learning model are generated. Specifically, the size m*n of each curvilinearly stiffened structure image is determined. According to the corresponding structural mechanical response of the image, the training datasets N₁ and testing datasets N₂ for supervised learning model are generated. In addition, the evaluation criteria for the model are set, as shown in Equation (1.2), and the root mean square error (RMSE) is selected as the error evaluation of the model;

$$\% RMSE = 100 \frac{\sqrt{\frac{1}{n} {\sum }_{i = 1}^{n} {( {y}_{i} - {\tilde{y}}_{i} )}^{2}}}{\frac{1}{n} {\sum }_{i = 1}^{n} {y}_{i}} \qquad ( 1.2 )$$

where n is the number of samples, yᵢ is the structural response value, and \tilde{y}ᵢ, is the predicted value of the model;

Step 204: the convolutional neural network model F is constructed by the decoding network model E of step 108 and two full connection layers;

Step 205: input the training datasets N₁ with mechanical response labels into convolutional neural network model F for training;

Step 206: the accuracy of convolution neural network model F is determined according to the testing datasets N₂, and the training process of convolution neural network for the mechanical response of curved stiffened structure is completed;

Step 300: based on the convolutional neural network model F of step 206 for predicting the mechanical response of curved stiffened structures, the evolutionary algorithm is used to complete the optimization design of the layout of curvilinearly stiffened structures, including the following sub-steps:

Step 301: build an evolutionary algorithm optimization framework, and the iterative start of optimization generates the initial curvilinearly stiffened image set N_{g};

Step 302: input the image set N_{g} into the convolutional neural network model F extracted by step 206.

Step 303: obtain a new sample point K by using evolutionary algorithm on the established convolutional neural network model F.

Step 304: curvilinearly stiffened structure model is established from the obtained sample point K, and marked by mechanical response analysis.

Step 305: add the new sample point K to the training image set N_{g} to form the image set N_{g+k}, and then enter the convolution neural network model F in step 206 for retraining.

Step 306: retrain the convolutional neural network model F instead of the convolutional neural network model F in step 302, and continue the optimization process of evolutionary algorithms.

Step 307: determine whether the current optimization process meets the convergence condition of the algorithm. If it converges, the optimal design variable is output. Otherwise, step 303 is returned, where the convergence condition is the maximum number of iterations to achieve the optimization algorithm.

Furthermore, in step 101, the selected path function requires that the curvature of the constraint function cannot be too large and the intermediate path of the function cannot exceed the design area, including but not limited to the spline function.

Furthermore, in step 103, the pixel size of the structural image in the image set is not fixed, which can be adjusted according to the complexity of the specific research structure.

Furthermore, in Step 104 and Step 105, the network structure and hyper-parameters used to build the autoencoder network model should be adjusted according to specific research questions.

Further, in step 202, the mechanical response of the structure includes static, dynamic or structural buckling response characteristics, and the analytical methods used can be finite element analysis, boundary element analysis, isogeometric analysis and meshless analysis.

Further, in Step 203, the number of samples in the generated training datasets and testing datasets can be adjusted according to the research questions. The adopted model error evaluation needs to be global, including but not limited to % RSME.

Further, in step 205, the error of convolutional neural network model will gradually converge with the increase of training steps, and the setting of training steps can be adjusted according to the complexity of the overall optimization problem and the comprehensive optimization efficiency of the model convergence speed.

Further, the evolutionary algorithms in step 301 include genetic algorithm, simulated annealing algorithm, artificial neural network algorithm, particle swarm optimization algorithm and ant colony algorithm.

Further, the steps 301 to 307 need to optimize the fixed number of curvilinear stiffeners and the variable number of curvilinear stiffeners respectively. In the process of optimizing the layout design of the variable number of curvilinear stiffeners, because the convolutional neural network formed by steps 100 and 200 has completed the learning process of structural characteristics and mechanical response of the curvilinear stiffeners image, there is no need to generate an additional training sets of variable curvilinear stiffeners s. Only the optimization process of steps 301 to 307 based on the program code of variable curvilinear stiffeners can realize the layout optimization design of curvilinearly stiffened structure with dynamic variable number of curvilinear stiffeners.

The beneficial effect of the present invention is as follows: an intelligent design method for the layout of curvilinearly stiffened structure based on image feature learning is proposed, and a convolution neural network model from the curve path representation image to the structural mechanical response prediction is built which is further applied to the optimization design of the layout of curvilinearly stiffened structure. Compared with the traditional surrogate-based optimization, the deep learning network model based on curvilinearly stiffened image has better structural response prediction effect, and the feasible optimal solution is obtained by curve layout optimization. The invention is expected to become one of the most potential methods involved in the optimization design of component layout in engineering structures.

### BRIEF DESCRIPTION OF THE DRAWINGS

FIG. 1 shows the flow chart of the intelligent design method of curvilinearly stiffened layout based on image feature learning provided by the implementation example of the invention.

FIG. 2 is the structure of image feature learning network. FIG. 2 (a) is the autoencoder network model structure for image encoding and decoding. FIG. 2 (b) is a convolutional neural network model that connects the encoding network with the fully connected network. The numerical changes in the graph represent the size changes of the input image processed layer by layer.

FIG. 3 is the convergence graph of the autoencoder network model training process.

FIG. 4 shows the effect of the input curvilinearly stiffened image after 20000 steps of self-learning training FIG. 4 (a) is the input image of curvilinearly stiffened structure, and FIG. 4 (b) is the output image after autoencoder network model training.

FIG. 5 is the illustration of boundary conditions. The value in the figure represents the size of load.

FIG. 6 shows the lightweight optimization process of image sample sets with fixed number of curvilinear stiffeners.

FIG. 7 shows the lightweight optimization process of the image sample set with variable number of curvilinear stiffeners.

### DETAILED DESCRIPTION

To make the solved technical problems, the adopted technical solution and the achieved technical effect of the present invention more clear, the present invention will be further described below in detail in combination with the drawings. It should be understood that specific embodiments described herein are only used for explaining the present invention, not used for limiting the present invention. In addition, it should be noted that, for ease of description, the drawings only show some portions related to the present invention rather than all portions.

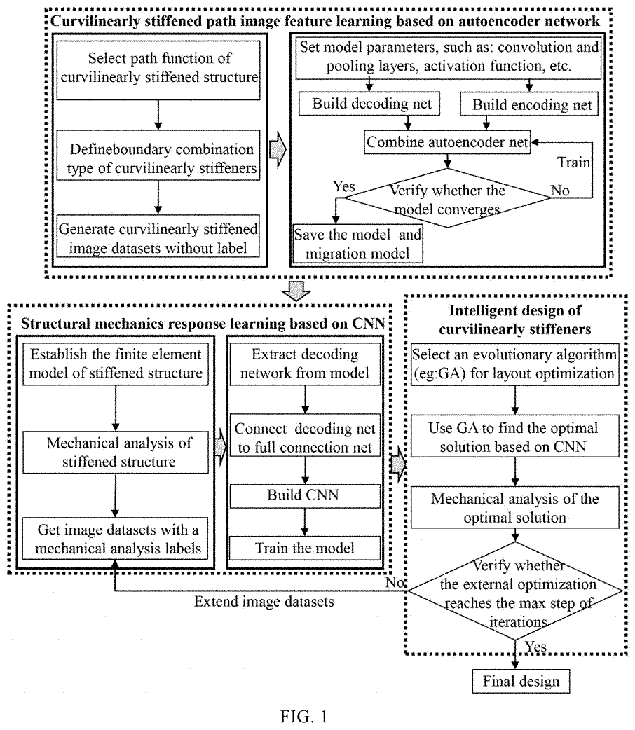

FIG. 1 shows the flow chart of the intelligent design method based on image feature learning for the layout of curvilinearly stiffened structures provided by the invention. The image and deep learning network involved in the invention are generated in the TensorFlow environment based on Python language. An image feature learning process for intelligent design of curvilinearly stiffened structure layout provided in the embodiment of the invention comprises the following steps:

Step 100: The quadratic Bezier spline function is selected as the stiffened path function, and the design variables of the path function are constrained according to the domain space of the stiffened thin-walled structure design. The image sets for unsupervised training are generated, and the autoencoder network constructed by multiple convolution layers and pooling layers is further input. After training, the autoencoder network model for image structure feature extraction is obtained, which includes the following sub-steps:

Step 101: determine the control parameters of the stiffened path function based on the quadratic Bezier spline function, as shown in formula (1.1), where B(t) is the path function, t is the path function control variable, Pₛ(xₛ, yₛ) is the starting point coordinates in the path, Pₘ(xₘ, yₘ) is a point coordinates in the path, Pₑ(xₑ, yₛ) is the end point coordinates in the path.

B(t)=(1−t)²Pₛ(xₛ,yₛ)+2t(1−t)Pₘ(xₘ,yₘ)+t²Pₑ(xₑ,yₑ),t∈[0,1] (1.1)

Step 102: six types of stiffened paths are determined according to the different boundary combinations of the starting and ending points of the curvilinearly stiffened path. Four types are selected for combination to obtain the curvilinearly stiffened structure controlled by 20 variables, and then the stiffened variables are constrained according to the design space of the stiffened thin-walled structure.

Step 103: generate 10000 image sets N₀ based on the type of curve path function, and set the size of each image to 64*64.

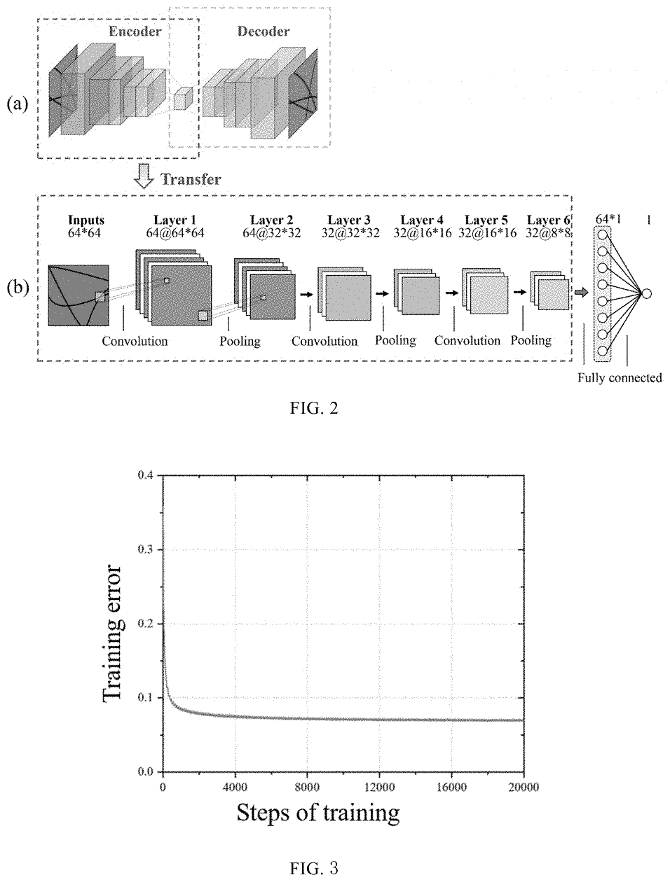

Step 104: the image decoding network model E is constructed by three convolution layers and three pooling layers, and the image encoding network model D is constructed by three deconvolutions. The autoencoder network model of image self-learning is formed by combination. The specific network model structure is shown in FIG. 2 (a).

Step 105: adjust the hyper-parameters in the autoencoder network model, such as: learning rate 0.001, convolution kernel size 3*3, data input batch 100, training steps 20000, etc. Determine the type of Loss function, as shown in formula (1.3), where N is the data training input batch, o₍ₙ₎ is the input image for autoencoder network, y₍ₙ₎ is the output image for autoencoder network.

$$Loss = \frac{1}{N} {a}_{n = 1}^{{∘}^{N}} {}_{{\hat{e}}_{e}}^{{\hat{e}}^{{e}^{'}}}{y}{}_{}^{( n ) ′} log \frac{1}{1 + {e}^{( - {o}^{( n )} )}} - {( 1 - {y}^{( n )} )}^{′} log \frac{1}{1 + {e}^{( - {o}^{( n )} )}} {}_{{{u}^{'}}_{\hat{u}}}^{{{u}^{'}}^{{u}^{‘}}} \qquad ( 1.3 )$$

Step 106: train the autoencoder network model in step 105 by batch inputting 10000 curvilinearly stiffened image sets N₀ in step 103.

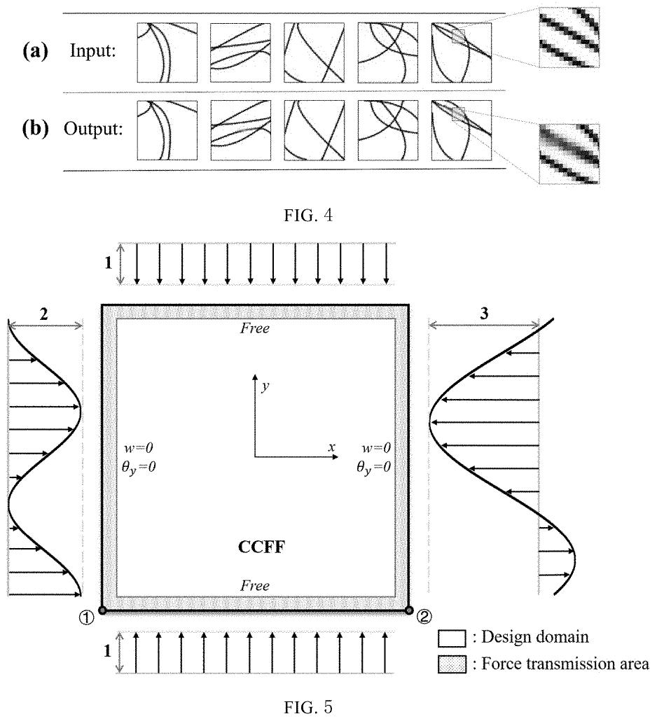

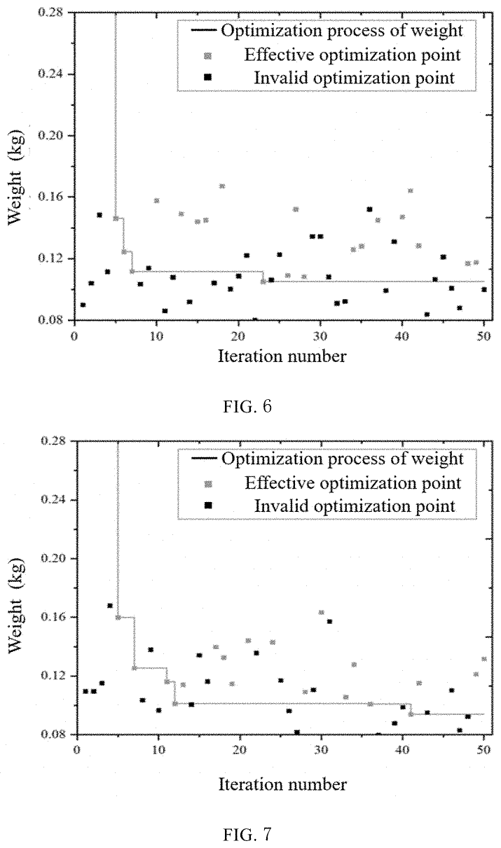

Step 107: complete the image training process. The training process is shown in FIG. 3. After 20000 steps of autoencoder network model training, the training effect of image self-learning is shown in FIG. 4.

Step 108: extract the decoding network model E after the autoencoder network model training.

Step 200: the finite element model is created according to the curve path type function, and the structural linear buckling analysis is carried out to obtain the data set for supervised learning. Further input the convolutional neural network model constructed by step 108 decoding network model and two full connection layers. After training, the learning process of structural mass and buckling eigenvalue response is completed, including the following sub steps:

Step 201: according to the curvilinearly stiffened path function determined by step 101, the finite element numerical model of variable number and fixed number of stiffeners is established by ABAQUS commercial software. In this case, the size of the stiffened thin-walled structure is 629.6*731.2 mm, the skin thickness is 1.5 mm, the height and width of the stiffeners are 18.0 mm and 2.4 mm, the structural material is AL2139, the Young's modulus is 72.50 GPa, the Poisson's ratio is 0.3, the density is 2.8e−6 kg/mm3.

Step 202: as shown in FIG. 5, set the boundary conditions of simply supported displacement on the four sides, set the boundary conditions of axial-shear combined load, apply unit 1 shear on the four sides, apply unit 1 axial force on the upper and lower sides, apply uneven axial force on the left and right sides, as shown in formula (1.4) and formula (1.5), where P_{left} is the left axial force and P_{right} is the right axial force, l is the height of the curvilinearly stiffened plate, and further complete the finite element linear buckling analysis of the curvilinearly stiffened structure.

$$\begin{matrix}{P}_{left} = sin ( \frac{3 π}{l} y ) + 1 & ( 1.4 ) \\ {P}_{right} = 2 sin [ \frac{2 π}{l} ( y + \frac{l}{8} ) ] + 1 & ( 1.5 )\end{matrix}$$

Step 203: five groups of 250 curvilinearly stiffened structural images with labels including mass and buckling eigenvalue were generated by Latin hypercube sampling five times independently in the design domain space. A set of images was selected as the training set N₁, and the other four groups were selected as the testing set for cross-validation N₂. The root mean square error (% RMSE) was selected as the error evaluation of the model, as shown in formula (1.2), where n is the number of samples, which yᵢ is the structural response value and \tilde{y}ᵢ is the model prediction value.

$$\% RMSE = 100 \frac{\sqrt{\frac{1}{n} {\sum }_{i = 1}^{n} {( {y}_{i} - {\tilde{y}}_{i} )}^{2}}}{\frac{1}{n} {\sum }_{i = 1}^{n} {y}_{i}} \qquad ( 1.2 )$$

Step 204: the convolutional neural network model is constructed by the decoding network model E extracted from step 108 and two full connection layers.

Step 205: input the labeled training set into the convolutional neural network model and train, the learning rate is 0.005, the data input batch is 100, the training steps is 1000. During the training process, only the parameters in the last two full connection layers need to be trained and adjusted.

Step 206: complete the training process of multiple sets of images, and extract the trained convolutional neural network model.

Step 300: based on the convolution network model of step 206 for predicting the mass and buckling eigenvalue of the curvilinearly stiffened structure, the genetic optimization algorithm is used to select the buckling eigenvalue of the curvilinearly stiffened structure not more than 8.40 as the constraint condition, and the layout optimization design of the lightweight curvilinearly stiffened structure is carried out, which includes the following sub steps:

Step 301: the genetic algorithm optimization framework is built. The number of initial population is set to 150 at the beginning of the optimization iteration, and the genetic algebra is set to be 15. The maximum optimization number is 50. The initial population curve reinforcement image set Ng is generated, and the size of each image is 64*64.

Step 302: input the image set Ng generated by the initial population into the convolutional neural network extracted from Step 206.

Step 303: the convolutional neural network model is used to optimize the layout of curvilinearly stiffened structures based on genetic algorithm, and a new sample point K is obtained.

Step 304: the finite element model is established about the obtained sample point K, and the structural linear buckling analysis is carried out to complete the marking of the sample point.

Step 305: the obtained sample point K generates an image of 64*64 size, which is added to the training image set, and further the expanded image set N_{g}+k is input into the convolutional neural network in step 206 for retraining.

Step 306: retrain the convolutional neural network model F instead of the convolutional neural network model F in step 302, and continue the optimization process of evolutionary algorithms.

Step 307: determine whether the genetic algorithm optimization process reaches the maximum number of iterations convergence, if convergence, output the optimal design variables and structural buckling eigenvalue, otherwise, return to step 303.

In view of the layout design problem of thin-walled curvilinearly stiffened structure, the present invention designs the feature learning method of curvilinearly stiffened path representation image, and fully excavates the structural information in the image. The root mean square error of the prediction of structural mass and buckling eigenvalue response of the convolution neural network model is about 5%, which greatly ensures the model accuracy in the layout design problem of curvilinearly stiffened structure. The convolution neural network model is used to carry out the lightweight design of curve stiffened structure based on genetic algorithm. Compared with the lightest mass of 0.133 in the sample, the optimal result of lightweight quality based on convolution neural network is 0.100, and the weight reduction ratio is 24.8%. In addition, the optimal result of lightweight quality of variable curvilinear stiffeners is 0.0954, and the weight reduction ratio is 28.3%. The invention is a deep learning method based on structural image feature extraction. Compared with the traditional surrogate-based optimization method, the model accuracy of the multivariable complex structure optimization problem is significantly improved, and the curvilinearly stiffened layout design with higher bearing efficiency of structural mechanics is obtained.

Finally, it should be noted that the above various embodiments are only used for describing the technical solution of the present invention rather than limiting the present invention. Although the present invention is already described in detail through the above various embodiments, those ordinary skilled in the art shall understand: the technical solution recorded in each of the embodiments can be still amended, or some or all technical features therein can be replaced equivalently without enabling the essence of the corresponding technical solution to depart from the scope of the technical solution of various embodiments of the present invention.

1. An intelligent design method of curvilinearly stiffened structure layout based on image feature learning, comprising steps of:
step 100: selecting curvilinearly stiffened path function to generate image datasets, which is input into autoencoder network for unsupervised learning training, and completing extraction of structural characteristics of curvilinearly stiffened image, including following sub-steps:
step 101: selecting path function B(t), and determining path function design variables of stiffened thin-walled structure, as shown in formula (1.1);
B(t)=(1−t)²Pₛ(xₛ,yₛ)+2t(1−t)Pₘ(xₘ,yₘ)+t²Pₑ(xₑ,yₑ),t∈[0,1] (1.1)
where B(t) is path function, t is path function control variable, Pₛ (xₛ, yₛ) is starting point coordinates in the path, Pₘ(xₘ, yₘ) is a point coordinates in the path, Pₑ(xₑ, yₑ) is end point coordinates in the path;
step 102: determining path function type according to combination of different boundary types of the structure, and constraining design domain space of the path function of the curvilinearly stiffened structures;
step 103: determining size of each curvilinearly stiffened structural image, m*n, and generating training image datasets N₀ used for unsupervised learning;
step 104: building decoding network model E and encoding network model D for layout image of curvilinearly stiffened structures;
step 105: combining the image decoding network model E and the encoding network model D to form autoencoder network model;
step 106: inputting curvilinearly stiffened layout image datasets N₀ into the autoencoder network model;
step 107: completing training process of the autoencoder network model for the curvilinearly stiffened layout image datasets No;
step 108: extracting the decoding network model E after the autoencoder network model trained;
step 200: establishing analysis model of mechanical response of curved stiffened structure, form training datasets for supervised learning, and further inputting convolutional neural network model built by step 108 decoding network model and full connection layer to complete learning of mechanical response of curved stiffened structure, including following sub-steps:
step 201: establishing curvilinearly stiffened structure according to the curve path function B (t);
step 202: setting boundary conditions and analyze structural mechanical response;
step 203: determining size m*n of each curvilinearly stiffened structure image; according to corresponding structural mechanical response of the image, generating training datasets N₁ and testing datasets N₂ for supervised learning model; in addition, setting evaluation criteria for the model, as shown in Equation (1.2), and selecting root mean square error (% RMSE) as error evaluation of the model;
$$\% RMSE = 100 \frac{\sqrt{\frac{1}{n} {\sum }_{i = 1}^{n} {( {y}_{i} - {\tilde{y}}_{i} )}^{2}}}{\frac{1}{n} {\sum }_{i = 1}^{n} {y}_{i}} \qquad ( 1.2 )$$
where n is number of samples, yᵢ is structural response value, and \tilde{y}ᵢ is predicted value of the model;
step 204: constructing convolutional neural network model F by the decoding network model E of step 108 and two full connection layers;
step 205: inputting the training datasets N₁ with mechanical response labels into convolutional neural network model F for training;
step 206: determining accuracy of the convolution neural network model F according to the testing datasets N₂, and completing training process of convolution neural network for the mechanical response of curved stiffened structure;
step 300: based on the convolutional neural network model F of step 206 for predicting the mechanical response of curved stiffened structures, using evolutionary algorithm to complete optimization design of layout of curvilinearly stiffened structures, including following sub-steps:
step 301: building an evolutionary algorithm optimization framework, optimizing iterative start to generate initial curvilinearly stiffened image set N_{g};
step 302: inputting the image set N_{g} into the convolutional neural network model F extracted by step 206;
step 303: obtaining a new sample point K by using evolutionary algorithm on the established convolutional neural network model F;
step 304: establishing curvilinearly stiffened structure model from the obtained sample point K, and marking by mechanical response analysis;
step 305: adding new sample point K to the training image set N_{g} to form image set N_{g+k}, and then entering the convolution neural network model F in step 206 for retraining;
step 306: replacing the convolutional neural network model F in step 302 with the retrained convolutional neural network model \tilde{F}, and continuing optimization process of evolutionary algorithms;
step 307: determining whether current optimization process meets convergence condition of the algorithm; if it converges, outputting optimal design variable; otherwise, returning step 303, where the convergence condition is maximum number of iterations to achieve optimization algorithm.

2. The intelligent layout design method for curvilinearly stiffened structures based on image feature learning according to claim 1, wherein step 101, the selected path function requires that curvature of constraint function cannot be too large and intermediate path of the function cannot exceed design area, including but not limited to spline function.

3. The intelligent layout design method for curvilinearly stiffened structures based on image feature learning according to claim 1, wherein step 202, the mechanical response of the structure includes static, dynamic or structural buckling response characteristics, and the analytical methods used can be finite element analysis, boundary element analysis, isogeometric analysis and meshless analysis.

4. The intelligent layout design method for curvilinearly stiffened structures based on image feature learning according to claim 1, wherein step 301, evolutionary algorithms include genetic algorithm, simulated annealing algorithm, artificial neural network algorithm, particle swarm optimization algorithm and ant colony algorithm.

5. The intelligent layout design method for curvilinearly stiffened structures based on image feature learning described in claim 1, wherein the steps 301 to 307 need to optimize the fixed number of stiffeners and the variable number of stiffeners respectively; in the process of optimizing the layout design of the variable number of stiffeners, because the convolutional neural network formed by steps 100 and 200 has completed the learning process of structural characteristics and mechanical response of the curved bar image, there is no need to generate an additional training sets of variable stiffeners; only the optimization process of steps 301 to 307 based on the program code of variable stiffeners can realize the layout optimization design of curvilinearly stiffened structure with dynamic variable number of stiffeners.
